(19) United States
(12) Patent Application Publication
(10) Pub. No.: US 2012/0103459 A1
(43) Pub. Date: May 3, 2012

(54) HIGH FATIGUE SERVICE LIFE QUENCHING/TEMPERING STEEL TUBE AND MANUFACTURING METHOD THEREFOR

(75) Inventors: Masaru Fujihara, Hiroshima (JP); Tsunetoshi Suzaki, Hiroshima (JP)

(73) Assignee: NISSHIN STEEL CO., LTD., Hiroshima (JP)

(21) Appl. No.: 12/914,150

(22) Filed: Oct. 28, 2010

(51) Int. Cl. F16L 9/02; C21D 9/08

(52) U.S. Cl. 138/177; 148/521

(57) ABSTRACT

Provided is a steel pipe designed to have a further increased high strength and a further improved fatigue life with suppressing the material cost and the production cost, especially such a steel pipe suitable for machine structure members that are required to be lightweight. The steel pipe is a high fatigue life steel pipe produced according to a process of using a steel plate having a composition that comprises, % by mass, C: 0.1 to 0.4%, Si: 0.5 to 1.5%, Mn: 0.3 to 2%, P: at most 0.02%, S: at most 0.01%, Cr: 0.1 to 2%, Ti: 0.01 to 0.1%, Nb: 0.01 to 0.1%, Al: at most 0.1%, B: 0.0005 to 0.01%, N: at most 0.01%, and optionally at least one of Ni: at most 0.5%, Ca: at most 0.02%, Mo: at most 0.5%, and V: at most 0.5%, with a balance of Fe and inevitable impurities, and having, on at least one side thereof, a smoothed surface of which the surface roughness Ra in the direction (C direction) perpendicular to the direction to be the longitudinal direction of the steel pipe is at most 0.5 μm, welding it into a pipe in such a manner that the smoothed surface thereof could be the inner surface of the steel pipe, and then quenching/tempering it.

### FIELD OF THE INVENTION

The present invention relates to a steel pipe obtained through quenching and tempering treatment and excellent in fatigue characteristics, especially to a steel pipe for machine structural members that has been designed to have a high strength by increasing the hardness thereof and to have a high fatigue life by precipitating fine carbides therein, and relates to a method for producing it.

### BACKGROUND ART

In various machine structures such as typically automobiles, often used are quenched/tempered “steel pipes” for members that are required to have a high strength and good fatigue characteristics.

In general, for improving the fatigue characteristics of steel materials, surface hardening or smoothing is said to be effective.
[Patent Reference 1] JP-A 6-264177
[Patent Reference 2] JP-A 7-215038
[Patent Reference 3] JP-A 2005-76047

### DISCLOSURE OF THE INVENTION

### Problems to be Solved by the Invention

Nowadays, various members of machine structures are increasingly required to be downsized and lightweight. High-strength members composed of steel pipes are no exceptions.

For making steel pipe members lightweight, it is most effective to reduce the pipe wall thickness thereof. However, thin-walled structures are disadvantageous in point of the strength and the fatigue life thereof. In particular, steel pipes are often worked to have a desired shape by bending or the like, but the outside wall of the bent part has a reduced thickness and is in a severe state in point of the durability. Accordingly, for satisfying the requirement for wall thickness reduction, it is desired to improve the level of the characteristics of steel pipes themselves, or that is, to elevate the fatigue life of steel pipes to a further higher level with maintaining the high strength thereof.

It is not always easy to reduce the pipe wall thickness of high-strength steel pipes with maintaining the durability thereof to that effect. As a means for solving the problem, for example, a method may be taken into consideration of improving the strength/fatigue characteristic level of steel materials themselves by addition of specific elements thereto. However, for many machine structures, such a method that may bring about material cost increase is unacceptable. The method of surface nitriding and the method of inner surface grinding as in Patent References 1 and 2 may be effective for improving fatigue characteristics, but both involve increase in process steps; and the current steel pipe production process could not be directly applied thereto. The method of inner surface grinding has another problem of process yield reduction. In the method of producing a steel pipe with controlling the cumulative reduction ratio to be at least 40% in hot rolling, as in Patent Reference 3, deteriorating in surface roughness occurred in hot rolling could hardly be improved.

In consideration of the current situation as above, the present invention is to provide a steel pipe that is designed to have a further increased high strength and a further improved fatigue life, with suppressing the material cost and the production cost to the level of conventional materials, especially to provide such a steel pipe suitable for wall thickness reduction in hollow stabilizers for automobiles.

### Means for Solving the Problems

The above-mentioned object can be attained by a high fatigue life steel pipe which is produced according to a process of using a steel plate having a composition that comprises, % by mass, C: 0.1 to 0.4%, Si: 0.5 to 1.5%, Mn: 0.3 to 2%, P: at most 0.02%, S: at most 0.01%, Cr: 0.1 to 2%, Ti: 0.01 to 0.1%, Nb: 0.01 to 0.1%, Al: at most 0.1%, B: 0.0005 to 0.01%, N: at most 0.01%, and optionally at least one of Ni: at most 0.5%, Ca: at most 0.02%, Mo: at most 0.5% and V: at most 0.5%, with a balance of Fe and inevitable impurities, and having, on at least one side thereof, a smoothed surface of which the surface roughness Ra (JIS B0601) in the direction (C direction) perpendicular to the direction to be the longitudinal direction of the steel pipe is at most 0.5 μm, welding it into a pipe in such a manner that the smoothed surface thereof could be the inner surface of the steel pipe, and then quenching/tempering it. A high fatigue life steel pipe having a wall thickness t of from 1 to 7 mm and an outer diameter D of the pipe of from 10 to 45 mm and satisfying D/t 4 is an especially preferred object.

As a production method for the steel pipe of the type, there is provided a method for producing a high fatigue life steel pipe, which comprises preparing a steel having the above-mentioned constitutive composition by melting, hot-rolling it under the condition [1] mentioned below, removing the scale, cold-rolling it under the condition [2] mentioned below, annealing it under the condition [3] mentioned below, forming it into a pipe under the condition [4] mentioned below, and quenching/tempering it under the condition [5] mentioned below.

[1] [Hot Rolling] The hot extrusion temperature is from 1100 to 1280° C. As the work roll in the hot-rolling final pass, preferably, a high speed tool steel roll (referred to “HSS roll”) is applied to the surface of the steel plate to be the inner surface side of the steel pipe.

[2] [Cold Rolling] The cold-rolling reduction ratio is at least 25%, and the surface of the steel plate to be the inner surface side of the steel pipe is made to have a surface roughness Ra of at most 0.5 μm in the direction (C direction) perpendicular to the direction to be the longitudinal direction of the steel pipe. In this case, more effectively, a smooth-finish work roll of which the surface roughness Ra in the direction parallel to the roll axis is at most 0.3 μm is applied to the surface of the steel plate to be the inner surface side of the steel pipe.

[3] [Annealing] The steel plate is heated in a non-oxidizing atmosphere to form a recrystallized texture therein.

[4] [Pipe Formation] The steel plate is formed into a steel pipe satisfying D/t≧4 where t means the wall thickness of the pipe and D means the outer diameter of the pipe.

[5] [Quenching/Tempering] The pipe is processed for quenching treatment of keeping it at 900 to 1100° C. for 10 to 60 seconds and then rapidly cooling it, followed by tempering treatment of keeping it at 280 to 380° C. for 10 to 60 minutes.

The invention has made it possible to significantly improve the fatigue life of high-strength steel pipes for use in various machine structural members with using inexpensive steel on the same level as that of conventional materials. Owing to the improvement in characteristics, further improvement in durability and further reduction in the wall thickness of members has been realized in hollow stabilizers for automobiles and in other steel pipes for machine structures.

### DESCRIPTION OF THE EMBODIMENTS

### <<Constitutive Composition>>

In the invention, used is a steel in which the content of each constitutive element is controlled as mentioned below. “%” indicating the alloying element content means “% by mass”.

C must be in an amount of at least 0.1% for the purpose of securing the strength and the spring property necessary for high fatigue life steel pipes for machine structures. However, when more than 0.4%, there may readily occur brittle fracture owing to toughness reduction, and there may occur a risk of fatigue life depression owing to the reduction in the grain boundary strength. If so, addition, the workability in pipe formation and the soundness of the welded part may worsen. Accordingly, the C content is defined to be from 0.1 to 0.4%.

Si is an element effective for improving the quenchability and the temper softening resistance and for securing the strength of the steel after tempering. In addition, in tempering, Si prevents the formation of filmy carbides and promotes the formation of fine carbides having a mean grain size of at most 0.5 μm, thereby preventing the reduction in the grain boundary strength of steel. Si is an indispensable element for attaining high fatigue life, and must be in an amount of at least 0.5%. However, when the Si content is more than 1.5%, coarse carbides may be formed in the grain boundary by which the fatigue life of steel may be rather lowered. Accordingly, the Si content is defined to be from 0.5 to 1.5%.

Mn is an element effective for securing the quenchability and the strength of steel; and for fully exhibiting the effect, Mn must be in an amount of at least 0.3%. However, if too much, the carbon equivalent may increase and too much Mn may have some negative influence on the workability and the soundness of the welded part of steel. Accordingly, the Mn content is defined to be within a range of from 0.3 to 2%.

P segregates in the austenite grain boundary in quenching, and owing to the reduction in the grain boundary strength, the fatigue life of steel is thereby lowered. Accordingly, the P content is defined to be at most 0.02%.

S forms MnS in steel, and this is the start point of cracking, thereby lowering the strength and the toughness of steel. In addition, S segregates in the grain boundary, therefore bringing about fatigue life reduction. Accordingly, the S content is defined to be at most 0.01%.

Like Mn, Cris effective for improving the quenchability of steel and increases the temper softening resistance, and therefore, Cr must be in an amount of at least 0.1%. However, when the Cr content is more than 2%, the quenched/tempered texture of steel may contain a large quantity of undissolved carbides, and the carbides form start points of cracking therefore causing reduction in the toughness and the fatigue life of steel. Accordingly, the Cr content is defined to be from 0.1 to 2%.

Ti fixes N in steel as TiN therein, therefore contributing toward securing the solid solute B effective for improving the quenchability of steel. In addition, Ti prevents prior austenite grains from further growing into coarse grains in quenching, therefore improving the fatigue life of steel. For fully exhibiting the effect, the Ti content must be at least 0.01%. However, even though Ti is added in an amount more than 0.1%, the effect thereof of preventing prior austenite grains from further growing into coarse grains may be saturated, and Ti-associated inclusions to be start points of fatigue fracture may rather increase. Accordingly, the Ti content is defined to be from 0.01 to 0.1%.

Nb forms Nb carbides and/or Nb nitrides and acts to prevent prior austenite crystal grains from further growing into coarse grains and to improve the toughness and the fatigue life of steel. For fully exhibiting the effect, the Nb content must be at least 0.01%. However, when the Nb content is more than 0.1%, the above effect would be saturated and it would be uneconomical. Accordingly, the Nb content is defined to be from 0.01 to 0.1%.

Al is an element effective for deoxidization and is also effective for preventing the austenite crystal grains from growing into coarse grains in quenching. As total Al (T.Al), the Al content is more effectively secured to be at least 0.01%. However, too much Al, if any, may have some negative influence on the toughness and the fatigue life of the electric resistant welded part of steel. Accordingly, the Al content (T.Al) is defined to be at most 0.1%, more preferably at most 0.05%.

Addition of a minor amount of B may be effective for increasing the quenchability of steel. In addition, B reinforces the prior austenite grain boundary after quench/tempere treatment to prevent the brittle fracture thereof, and is therefore effective for improving the toughness of steel. For fully exhibiting the effect, the B content must be at least 0.0005%. However, when more than 0.01%, the effect may be saturated. Accordingly, the B content is defined to be from 0.0005 to 0.01%, more preferably falling within a range of from 0.002 to 0.01%.

N consumes B in forming BN, and is therefore a negative factor in ensuring the effect of B added to steel. Accordingly, the N content is preferably as small as possible. As a result of various investigations, the N content may be acceptable up to 0.01%, but is more preferably at most 0.006%.

Ni forms carbonitrides and is effective for improving the quenchability, the toughness and the fatigue life of steel; and therefore, Ni may be added to steel, if desired. More effectively, the Ni content is secured to be at least 0.1%. However, if more than 0.5%, the above effect may be saturated and it would be uneconomical. Accordingly, the amount of Ni, if added, shall be within a range of at most 0.5%.

Ca has an effect of spheroidizing MnS-type inclusions in steel, by which the anisotropy of steel may be reduced. Accordingly, if desired, Ca may be added to steel, and more effectively, its content may be at least 0.001%. However, if too much, Ca-associated inclusions may increase in steel, thereby having some negative influence on the fatigue characteristics of steel. Accordingly, the amount of Ca, if added, shall be within a range of at most 0.02%.

Mo is an element effective for improving the quenchability and the temper softening resistance of steel, and is therefore secondarily added for preventing the toughness degradation to be caused by excess addition of Mn and Cr. Effectively, the Mo content is secured at least 0.1%, but more effectively at least 0.15%. However, Mo is an expensive element, and too much addition thereof detracts from the economical potential of the invention. Accordingly, Mo addition, if any, shall be within a range of at most 0.5%.

V has an effect of refining the crystal grains in quenching, and is effective for improving the toughness of steel; and therefore, V is optionally added to steel. More effectively, the V content is secured to be at least 0.1%. However, V is also an expensive element, and too much addition thereof detracts from the economical potential of the invention. Accordingly, V addition, if any, shall be within a range of at most 0.5%.

### <<Smoothness of Inner Surface of Steel Pipe>>

The present inventors' detailed investigations have revealed that the fatigue characteristics of the quenched/tempered steel pipe to be finally obtained greatly depend on the properties of the “starting steel plate” to be formed into a pipe. Specifically, when the surface of the “starting steel plate” to be the inner side of a steel pipe is smoothed, then the fatigue characteristics of the steel pipe to be derived from the starting steel plate can be improved.

Concretely, when a starting steel plate having, on at least one side thereof, a smoothed surface of which the surface roughness Ra in the direction (C direction) perpendicular to the direction to be the longitudinal direction of the steel pipe is at most 0.5 μm is prepared and when the plate is welded into a pipe in such a manner that the smoothed surface thereof could be the inner surface of the steel pipe and then the steel pipe is quenched/tempered, then in the thus-produced steel pipe, an inner surface of high smoothness capable of providing remarkable improvement of fatigue characteristics can be formed. The inner surface of the formed pipe is somewhat lower than the smoothness of the surface of the starting steel plate; however, when Ra is at most 0.5 μm, then the inner surface roughening caused by the pipe formation may have little negative influences on the fatigue characteristics of the steel pipe members such as stabilizers, etc.

### <<Dimensional Profile of Steel Pipe>>

For attaining the steel pipe inner surface of high smoothness capable of providing remarkable improvement of fatigue characteristics as above, more preferably, the steel pipe has a dimensional profile that satisfies D/t≧4 in relation between the wall thickness t and the outer diameter D of the pipe having a circular cross section. Specifically, it is effective to reduce the wall thickness of the pipe relative to the outer diameter thereof for reducing the surface irregularity (surface roughness) of the inner surface to be caused in working for pipe formation, and this is effective for improving the fatigue characteristics of the pipe. The wall thickness reduction brings about weight reduction in steel pipe members such as stabilizers, etc. For use for stabilizers and the like, the steel pipe preferably satisfies D/t≧4 where the wall thickness t is within a range of from 1 to 7 mm and the outer diameter D of the pipe is within a range of from 10 to 45 mm.

### <<Production Process>>

The steel pipe having excellent fatigue characteristics of the invention can be produced by preparing a steel having the above-mentioned constitutive composition by melting, and processing it according to a process of “hot rolling→treatment of scale removal→cold rolling→annealing→pipe formation→quenching/tempering”. In the process, the steps of hot rolling, cold rolling, annealing, pipe formation and quenching/tempering may be attained under the conditions [1] to [5] mentioned below.

[1] [Hot Rolling] The hot extrusion temperature is from 1100 to 1280° C.

When the hot extrusion temperature is low, then the amount of oxide scale formation on the slab surface may decrease and therefore the degree of surface roughness after washing with acid of the hot-rolled plate may be thereby reduced. Various investigations have confirmed that the hot extrusion temperature of not higher than 1280° C. is extremely advantageous for smoothing the starting steel plate for pipe formation to have a surface roughness Ra of at most 0.5 μm. However, when lower than 1100° C., the deformation resistance may increase and the surface of the hot-rolled plate may be readily cracked. If so, the desired surface smoothing would be difficult.

Also preferably, a HSS roll is used as the work roll in the hot-rolling final pass. When a HSS roll having a high surface hardness is used in the hot-rolling final pass, then the surface of the just hot-rolled plate could be smoothed to a considerably high degree.

The winding temperature in hot rolling is preferably not higher than 600° C. Accordingly, the scale layer in hot rolling can be thinned, therefore facilitating the smoothing operation in the subsequent steps.

The surface oxide scale on the thus-obtained, hot-rolled plate must be removed, and for the means, various methods of washing with acid, mechanical polishing or the like may be employed not detracting from the surface smoothness of the plate. The condition [1] mentioned above brings about a good result in ordinary washing with acid.

[2] [Cold Rolling] The cold-rolling reduction ratio is at least 25%, and the surface of the steel plate to be the inner surface side of the steel pipe is made to have a surface roughness Ra of at most 0.5 μm in the direction (C direction) perpendicular to the direction to be the longitudinal direction of the steel pipe.

When the cold-rolling reduction ratio is less than 25%, then the smoothing effect may be poor. With the increase in the cold-rolling reduction ratio, in general, the effect of smoothing by the cold rolling increases. The surface condition of the work roll used for the cold rolling also has some influence on the smoothing. Accordingly, by controlling the cold-rolling reduction ratio to fall within a range of at least 25% in accordance with the surface condition of the work roll used, the surface roughness Ra can be controlled to be at most 0.5 μm.

In the invention, more effectively, a smooth-finish work roll of which the surface roughness Ra in the direction parallel to the roll axis is at most 0.3 μm is applied to the surface of the steel plate to be the inner surface side of the steel pipe. Use of the work roll of the type attains the desired smoothing in an early stage where the reduction ratio is relatively low, and therefore broadens the latitude in condition setting as combined with the subsequent annealing to be mentioned below.

[3] [Annealing] The steel plate is heated in a non-oxidizing atmosphere to form a recrystallized texture therein.

The steel plate is formed into a pipe in cold working, and therefore, it must be fully softened to exhibit good workability. For this, the steel plate is annealed to form a recrystallized texture therein. However, for keeping the smoothness of the surface formed by the previous cold working, scale formation in this annealing step is unfavorable by itself, and scale removal by washing with acid or by mechanical treatment is more unfavorable as increasing the surface roughness of the processed steel plate. Accordingly, in the invention, the annealing is attained in a non-oxidizing atmosphere in which oxide scale is hardly formed. As the non-oxidizing atmosphere, herein employable is a mixed gas of nitrogen with at least 70% by volume of hydrogen, an atmosphere having a dew point of not higher than −60° C., or a hydrogen gas atmosphere. Accordingly, the annealing does not require any subsequent step of oxide scale removal. In addition, since the steel plate has already been smoothed to a desired degree, it may be directly formed into a pipe not requiring any additional polish finishing. The hydrogen gas atmosphere preferably has a hydrogen concentration of at least 99.99%.

Suitable conditions may be employed for the annealing temperature and time, depending on the cold-rolling reduction ratio in the previous step. In general, the steel plate that has been cold-rolled to a higher reduction ratio could have a fine recrystallized texture formed at a lower temperature within a shorter period of time. Depending on the constitutive composition of steel, there may be some difference in the optimum condition. For the steel plate having attained a total cold-rolling reduction ratio of at least 25% in the previous step, for example, the annealing condition may be at from 670 to 750° C. and for from 10 to 40 hours.

[4] [Pipe Formation] The steel plate is formed into a pipe satisfying D/t≧4 where t means the wall thickness of the pipe and D means the outer diameter of the pipe.

For pipe formation, herein employable is an ordinary pipe formation method where a steel strip is continuously led to pass between shaping rolls to deform it into a tube-like form and the opposite edges facing each other are welded together. High frequency welding or TIG welding may be employed here. As described in the above, a thinner wall relative to the outer diameter of pipe is more effective for reducing the inner surface irregularity (roughness) of pipe to occur in pipe formation, and this is effective for improving the fatigue characteristics of pipe. Accordingly, the steel plate is preferably formed into a pipe of which the dimensional profile satisfies D/t≧4.

[5] [Quenching/Tempering] The pipe is processed for quenching treatment of keeping it at 900 to 1100° C. for 10 to 60 seconds and then rapidly cooling it, followed by tempering treatment of keeping it at 280 to 380° C. for 10 to 60 minutes.

As a result of the quenching/tempering treatment, the fatigue life of the thus-processed steel pipe can be significantly improved while the hardness in the center part of the wall thickness in the cross section perpendicular to the longitudinal direction of the steel pipe (hereinafter this may be referred to as “cross section C”) is kept on a strength level of at least 400 HV. “Rapid cooling” in the quenching treatment is at a cooling speed enough to undergo martensitic transformation, for which, for example, employable is “cooling in water” by dipping the steel pipe in water.

Subsequently, the outer surface of the steel pipe may be hardened depending on the use thereof. For example, ordinary shot-peening treatment or the like means may be employed.

### EXAMPLES

A steel in Table 1 was smelted, the slab was heated at 1050 to 1320° C. for 60 minutes, then extruded, hot-rolled, and wound at 530 to 580° C. In this, an example of using an ordinary grain roll for the work roll in each stand of the finish rolling machine, and an example of using a hard HSS roll were set. In every case, the winding temperature was within a range of from 530 to 580° C. Next, the steel plate was washed with acid in an ordinary manner. The steel plate in this stage is referred to as “hot-rolled plate”. Subsequently, as shown in Table 2 below, this was not cold-rolled (this case is shown to have a cold-rolling reduction ratio of 0%), or was cold-rolled under a different reduction ratio to thereby control the surface roughness of the plate. An example of using a dull roll as the work roll in the cold rolling step, and an example of using a smooth-finishing work roll having a surface roughness Ra in the roll axial direction of at most 0.3 μm were set. By controlling the hot-rolling reduction ratio and the cold-rolling reduction ratio, the thus cold-rolled steel plate was finished to have a thickness of 4.0 mm. After the cold rolling, the steel plate was annealed in a hydrogen atmosphere (H₂: 99.99%) at 700° C. for 15 hours; and thus processed, this is “starting steel plate” having a thickness of 4.0 mm. The steel plate processed through the process of hot rolling→cold rolling→annealing is referred to as “cold-rolled annealed plate”, and the steel plate processed through the process of hot rolling→annealing where cold rolling was omitted is referred to as “hot-rolled annealed plate”. In this, both two surfaces of the starting steel plate were finished quite in the same manner with no specific differentiation between one surface and another surface.

TABLE 1

| | Chemical Composition (% by mass) | | | | | | | | | | | | | | | |
|---|---|---|---|---|---|---|---|---|---|---|---|---|---|---|---|---|
| Steel | C | Si | Mn | P | S | Cr | Ti | Nb | T•Al | B | N | Ni | Ca | Mo | V | Classification |
| a | 0.23 | 1.05 | 0.87 | 0.012 | 0.006 | 0.33 | 0.02 | 0.05 | 0.019 | 0.004 | 0.0052 | — | — | — | — | Steel in |
| b | 0.22 | 0.69 | 0.72 | 0.009 | 0.008 | 1.11 | 0.04 | 0.04 | 0.024 | 0.006 | 0.0039 | — | — | — | — | the |
| c | 0.26 | 1.15 | 1.39 | 0.012 | 0.005 | 1.47 | 0.03 | 0.06 | 0.023 | 0.006 | 0.0052 | — | 0.04 | — | — | Invention |
| d | 0.14 | 0.66 | 0.65 | 0.008 | 0.003 | 0.81 | 0.04 | 0.03 | 0.032 | 0.004 | 0.0039 | — | — | 0.38 | — | |
| e | 0.37 | 0.80 | 1.33 | 0.013 | 0.008 | 0.46 | 0.03 | 0.05 | 0.028 | 0.005 | 0.0051 | — | — | — | 0.26 | |
| f | 0.29 | 1.43 | 0.86 | 0.015 | 0.004 | 1.75 | 0.02 | 0.02 | 0.033 | 0.009 | 0.0045 | 0.34 | — | — | — | |
| g | 0.32 | 0.65 | 0.85 | 0.013 | 0.005 | 1.39 | 0.04 | 0.03 | 0.021 | 0.008 | 0.0038 | — | — | — | — | |
| h | 0.37 | 0.82 | 0.58 | 0.011 | 0.018 | 1.53 | 0.03 | 0.03 | 0.035 | 0.007 | 0.0041 | — | — | — | — | |
| i | 0.13 | 0.76 | 1.53 | 0.013 | 0.008 | 0.87 | 0.02 | 0.04 | 0.029 | 0.005 | 0.0045 | — | — | — | — | |

Using a surface roughness profile analyzer (ACCRETECHz's 1400D-12), the surface of the starting steel plate was analyzed to measure the surface roughness Ra thereof in the direction (C direction) perpendicular to the rolling direction. The length for measurement was 3 mm, the cut-off length was 0.25 mm, and the slope correction was least squares curve correction.

Next, the above-mentioned starting steel plate was formed through high-frequency welding into a steel pipe having an outer diameter, D of 25.4 mm. Its wall thickness, t was 4.0 mm. The surface of which the surface roughness was measured was made to be the inner surface of the steel pipe.

The steel pipes thus formed by welding (starting steel pipes) were cut into a length of 1 m. These were processed for quenching treatment of “keeping at 1000° C. for 30 seconds followed by rapidly cooling in water” and tempering treatment of “keeping at 340° C. for 45 minutes followed by cooling in air”. Subsequently, the outer surface of the steel pipe was hardened through ordinary shot-peening treatment.

Each steel pipe (electric resistant welded pipe) was tested according to a fatigue test in which 100 mm of both ends of the steel pipe were fastened and twisting stress was given to the steel pipe in the circumferential direction thereof.

In this, a strain gauge was fitted to the outer surface in the center part in the longitudinal direction of the steep pipe, and a twisting stress of 700 N·mm⁻² was imparted to the sample. In this test, when the fracture lifetime is 200,000 times or more (that is, 2×10⁵ times or more), then the steel pipe tested here is recognized to have a greatly increased fatigue life as compared with conventional hollow stabilizers. In this, therefore, the samples having a fracture lifetime of at least 200,000 times were evaluated as good (O), and those less than the level were evaluated as not good (x). At the time when the fracture lifetime was over 1,000,000 times (10×10⁵ times), the fatigue test was stopped.

The results are shown in Table 2.

TABLE 2

| | | | Hot Rolling | | | Cold Rolling | |
|---|---|---|---|---|---|---|---|
| | | | extrusion | winding | | cold-rolling | |
| | | | temperature | temperature | hot-rolling work | reduction ratio | |
| No. | Steel | Steel Plate | (° C.) | (° C.) | roll | (%) | cold-rolling work roll |
| 1 | a | hot-rolled plate | 1200 | 550 | grain roll | 0 | — |
| 2 | | cold-rolled annealed plate | 1250 | 550 | grain roll | 28 | smooth-finish roll |
| 3 | | hot-rolled plate | 1250 | 550 | grain roll | 0 | — |
| 4 | | hot-rolled annealed plate | 1280 | 530 | grain roll | 0 | — |
| 5 | | cold-rolled annealed plate | 1140 | 540 | HSS roll | 41 | smooth-finish roll |
| 6 | | cold-rolled annealed plate | 1170 | 550 | HSS roll | 35 | dull roll |
| 7 | | cold-rolled annealed plate | 1170 | 550 | grain roll | 32 | dull roll |
| 8 | b | cold-rolled annealed plate | 1150 | 540 | HSS roll | 52 | smooth-finish roll |
| 9 | | cold-rolled annealed plate | 1220 | 550 | grain roll | 42 | smooth-finish roll |
| 10 | | hot-rolled plate | 1260 | 580 | HSS roll | 0 | — |
| 11 | | cold-rolled annealed plate | 1320 | 550 | HSS roll | 34 | dull roll |
| 12 | | cold-rolled annealed plate | 1050 | 530 | grain roll | 33 | dull roll |
| 13 | | cold-rolled annealed plate | 1220 | 540 | grain roll | 22 | dull roll |
| 14 | | cold-rolled annealed plate | 1220 | 530 | grain roll | 29 | dull roll |
| 15 | | hot-rolled plate | 1220 | 550 | grain roll | 0 | — |
| 16 | | cold-rolled annealed plate | 1250 | 580 | grain roll | 35 | dull roll |
| 17 | c | cold-rolled annealed plate | 1220 | 530 | grain roll | 37 | dull roll |
| 18 | d | cold-rolled annealed plate | 1250 | 550 | grain roll | 42 | dull roll |
| 19 | e | cold-rolled annealed plate | 1250 | 550 | grain roll | 33 | dull roll |
| 20 | f | cold-rolled annealed plate | 1250 | 530 | grain roll | 30 | dull roll |
| 21 | g | cold-rolled annealed plate | 1220 | 550 | grain roll | 32 | dull roll |
| 22 | h | cold-rolled annealed plate | 1250 | 550 | grain roll | 35 | dull roll |
| 23 | i | cold-rolled annealed plate | 1220 | 550 | grain roll | 36 | dull roll |

| | Surface | | | |
|---|---|---|---|---|
| | Roughness of | | | |
| | Starting Steel | Fracture Lifetime | | |
| | Plate Ra | times | | |
| No. | (μm) | (×10⁵) | Evaluation | Classification |
| 1 | 3.16 | 0.87 | X | comparative example |
| 2 | 0.35 | 3.20 | ◯ | example of the invention |
| 3 | 3.54 | 0.91 | X | comparative example |
| 4 | 3.73 | 0.85 | X | comparative example |
| 5 | 0.24 | >10 | ◯ | example of the invention |
| 6 | 0.35 | 3.23 | ◯ | example of the invention |
| 7 | 0.41 | 2.95 | ◯ | example of the invention |
| 8 | 0.22 | >10 | ◯ | example of the invention |
| 9 | 0.30 | 4.56 | ◯ | example of the invention |
| 10 | 3.62 | 0.95 | X | comparative example |
| 11 | 0.59 | 0.78 | X | comparative example |
| 12 | 0.78 | 0.78 | X | comparative example |
| 13 | 0.62 | 1.14 | X | comparative example |
| 14 | 0.41 | 3.06 | ◯ | example of the invention |
| 15 | 4.11 | 0.78 | X | comparative example |
| 16 | 0.37 | 2.82 | ◯ | example of the invention |
| 17 | 0.38 | 2.43 | ◯ | example of the invention |
| 18 | 0.39 | 3.54 | ◯ | example of the invention |
| 19 | 0.43 | 2.52 | ◯ | example of the invention |
| 20 | 0.35 | 2.64 | ◯ | example of the invention |
| 21 | 0.33 | 3.61 | ◯ | example of the invention |
| 22 | 0.36 | 2.66 | ◯ | example of the invention |
| 23 | 0.40 | 2.61 | ◯ | example of the invention |

Underlined: outside the scope of the invention.

As known from Table 2, the steel pipes of the invention, which were produced according to a process of using a starting steel plate that had been smoothed to have a surface roughness Ra of at most 0.5 μm in the direction (C direction) perpendicular to the direction to be the longitudinal direction of the steel pipe, and welding it into a pipe in such a manner that the smoothed surface thereof could be the inner surface of the steel pipe, all had a fracture lifetime of at least 200,000 times, and exhibited excellent fatigue characteristics durable for hollow stabilizers for automobiles. In particular, samples No. 5 and No. 8 for which a HSS roll was used as the hot-rolling roll and a smooth-finish roll was used as the cold-rolling roll had extremely excellent fatigue characteristics. All the steel pipes of examples of the invention were so confirmed that, after the pipe formation, the inner surface thereof had a surface roughness Ra of at most 0.5 μm in the C direction.

As opposed to these, for the steel pipes of comparative examples No. 1, No. 3, No. 4, No. 10 and No. 15, the starting steel plates were a hot-rolled plate or a hot-rolled annealed plate, and the surface roughness of the starting steel plates was over 0.5 μm, and therefore, the fatigue lifetime of those steel pipes was short. In No. 11, the hot extrusion temperature was too high and therefore the scale layer was thick, resulting in that the surface condition of the steel pipe was poor and the fatigue lifetime thereof was short. In No. 12, the hot extrusion temperature was too low and therefore the fine cracks were formed in the hot-rolled plate; and even though the plate was cold-rolled and annealed, its surface could not be sufficiently smoothed, therefore resulting in that the fatigue lifetime of the steel pipe was short.

In No. 13, the cold-rolling reduction ratio was 22% and was somewhat small, and therefore, the surface smoothing was insufficient and the fatigue lifetime of the steel pipe was short.

For reference, a photographic picture (optical microscopic photograph) of the metal texture in the cross section (cross section C) perpendicular to the rolling direction of the starting steel plate of No. 5 of an example of the invention is shown in FIG. 1.

### BRIEF DESCRIPTION OF THE DRAWING

FIG. 1 is an optical microscopic photograph of the cross section (C-cross section) perpendicular to the rolling direction of the starting steel plate of an example of the invention.

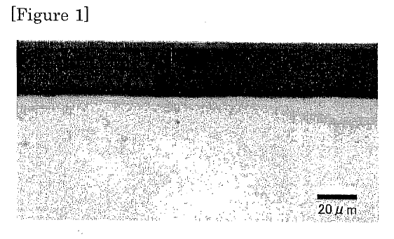

What is claimed is:

1. A high fatigue life steel pipe produced according to a process of using a steel plate having a composition that comprises, % by mass, C: 0.1 to 0.4%, Si: 0.5 to 1.5%, Mn: 0.3 to 2%, P: at most 0.02%, S: at most 0.01%, Cr: 0.1 to 2%, Ti: 0.01 to 0.1%, Nb: 0.01 to 0.1%, Al: at most 0.1%, B: 0.0005 to 0.01%, N: at most 0.01%, with a balance of Fe and inevitable impurities, and having, on at least one side thereof, a smoothed surface of which the surface roughness Ra in the direction (C direction) perpendicular to the direction to be the longitudinal direction of the steel pipe is at most 0.5 μm, welding it into a pipe in such a manner that the smoothed surface thereof could be the inner surface of the steel pipe, and then quenching/tempering it.

2. The high fatigue life steel pipe as claimed in claim 1, wherein the steel plate composition further contains at least one of Ni: at most 0.5%, Ca: at most 0.02%, Mo: at most 0.5%, and V: at most 0.5%.

3. The high fatigue life steel pipe as claimed in claim 1 or 2, which satisfies D/t≧4 wherein t is the wall thickness 1 to 7 mm of the pipe and D is the outer diameter 10 to 45 mm of the pipe.

4. A method for producing a high fatigue life steel pipe, which comprises preparing a steel having a composition comprising, % by mass, C: 0.1 to 0.4%, Si: 0.5 to 1.5%, Mn: 0.3 to 2%, P: at most 0.02%, S: at most 0.01%, Cr: 0.1 to 2%, Ti: 0.01 to 0.1%, Nb: 0.01 to 0.1%, Al: at most 0.1%, B: 0.0005 to 0.01%, N: at most 0.01%, with a balance of Fe and inevitable impurities, by melting, hot-rolling it under the condition [1] mentioned below, removing the scale, cold-rolling it under the condition [2] mentioned below, annealing it under the condition [3] mentioned below, forming it into a pipe under the condition [4] mentioned below, and quenching/tempering it under the condition [5] mentioned below:
[1] [Hot Rolling] The hot extrusion temperature is from 1100 to 1280° C.;
[2] [Cold Rolling] The cold-rolling reduction ratio is at least 25%, and the surface of the steel plate to be the inner surface side of the steel pipe is made to have a surface roughness Ra of at most 0.5 μm in the direction (C direction) perpendicular to the direction to be the longitudinal direction of the steel pipe;
[3] [Annealing] The steel plate is heated in a non-oxidizing atmosphere to form a recrystallized texture therein;
[4] [Pipe Formation] The steel plate is formed into a steel pipe satisfying D/t≧4 where t means the wall thickness of the pipe and D means the outer diameter of the pipe;
[5] [Quenching/Tempering] The pipe is processed for quenching treatment of keeping it at 900 to 1100° C. for 10 to 60 seconds and then rapidly cooling it, followed by tempering treatment of keeping it at 280 to 380° C. for 10 to 60 minutes.

5. The method for producing a high fatigue life steel pipe as claimed in claim 4, wherein the steel further contains at least one of Ni: at most 0.5%, Ca: at most 0.02%, Mo: at most 0.5%, and V: at most 0.5%.

6. The method for producing a high fatigue life steel pipe as claimed in claim 4 or 5, wherein in the hot rolling [1], a HSS roll is applied to the surface of the steel plate to be the inner surface side of the steel pipe, as the work roll in the hot-rolling final pass.

7. The method for producing a high fatigue life steel pipe as claimed in any of claims 4 to 6, wherein in the cold rolling [2], a smooth finish work roll of which the surface roughness Ra in the direction parallel to the roll axis is at most 0.3 μm is applied to the surface of the steel plate to be the inner surface side of the steel pipe.
